(19) United States
(12) Patent Application Publication
(10) Pub. No.: US 2015/0249265 A1
(43) Pub. Date: Sep. 3, 2015

(54) ALL SOLID-STATE BATTERY AND METHOD FOR PRODUCING SAME

(71) Applicant: Murata Manufacturing Co., Ltd., Nagaokakyo-shi (JP)

(72) Inventors: TADAAKI MATSUMURA, Nagaokakyo-shi (JP); Mika Tagami (nee Fukushima), Nagaokakyo-shi (JP)

(21) Appl. No.: 14/699,627

(22) Filed: Apr. 29, 2015

Related U.S. Application Data
(63) Continuation of application No. PCT/JP2013/079672, filed on Nov. 1, 2013.

(30) Foreign Application Priority Data
Nov. 7, 2012 (JP) 2012-245527

(51) Int. Cl. H01M 10/0562; H01M 4/58; H01M 10/0525; H01M 4/583

(52) U.S. Cl. CPC H01M 10/0562; H01M 4/583; H01M 4/5825; H01M 10/0525; H01M 2300/0068

(57) ABSTRACT

An all-solid-state battery that includes a positive electrode layer, a negative electrode layer and a solid electrolyte layer interposed between the positive electrode layer and the negative electrode layer. At least one electrode layer selected from the positive electrode layer and the negative electrode layer contains an electrode active material, a sulfide solid electrolyte and fibrous carbon. The fibrous carbon includes at least fibrous carbon components that extend in the direction of lamination of the positive electrode layer, the solid electrolyte layer and the negative electrode layer.

### CROSS REFERENCE TO RELATED APPLICATIONS

The present application is a continuation of International application No. PCT/JP2013/079672, filed Nov. 1, 2013, which claims priority to Japanese Patent Application No. 2012-245527, filed Nov. 7, 2012, the entire contents of each of which are incorporated herein by reference.

### FIELD OF THE INVENTION

The present invention relates to an all-solid-state battery and a method for producing the all-solid-state battery, and specifically relates to an all-solid-state battery utilizing a sulfide solid electrolyte and a method for producing the all-solid-state battery.

### BACKGROUND OF THE INVENTION

In recent years, secondary batteries have been increasingly demanded as cordless power supplies for mobile electronic devices such as mobile phones and note-type personal computers in association with the development of these electronic devices. Particularly, chargeable and dischargeable lithium ion secondary batteries each having a high energy density have been developed aggressively.

In a lithium ion secondary battery, a solution produced by dissolving, in an organic solvent, a metal oxide such as lithium cobaltate which serves as a positive electrode active material, a carbon material such as graphite which serves as a negative electrode active material, and lithium hexafluorophosphate which serves as an electrolyte, i.e., an organic solvent-type electrolytic solution, has been used generally. In a battery having this constitution, it is attempted to increase an internal energy, further increase an energy density and improve an output current by increasing the amounts of active materials. Furthermore, it has also been demanded to increase the size of the battery and to install the battery into a vehicle safely.

However, in a lithium ion secondary battery having a structure as mentioned above, an organic solvent which is used in an electrolyte is a flammable substance and therefore the battery has the risk of ignition. Therefore, it has been demanded to further improve the safety of the battery.

As one measure for improving the safety of a lithium ion secondary battery, the use of a solid electrolyte instead of an organic solvent-type electrolytic solution has been considered. As the solid electrolyte, the use of an organic material (e.g., a polymer and a gel) or an inorganic material (e.g., glass and ceramic) has been considered. Particularly, an all-solid-state secondary battery in which an inorganic material mainly composed of inflammable glass or ceramic is used as a solid electrolyte has been attracting attention.

For example, JP 2005-327528 A (referred to as “Patent Document 1” hereinbelow) discloses a solid-state battery in which Li₂S—SiS₂—P₂S₅, which is a lithium ion-conductive substance and can be synthesized by a mechanical milling treatment, is used as a solid electrolyte. In Patent Document 1, LiCoO₂ is used as a positive electrode active material, and metal lithium is used as a negative electrode active material. In Patent Document 1, it is described that LiCoO₂ is particularly preferred because LiCoO₂ has a large electrochemical capacity and the grain size of LiCoO₂ can be controlled relatively easily by selecting the conditions for the pulverization of LiCoO₂ properly.

Patent Document 1: JP 2005-327528 A

### SUMMARY OF THE INVENTION

However, an all-solid-state battery in which lithium cobaltate (LiCoO₂) is used as a positive electrode active material as disclosed in Patent Document 1 has a problem that the strength of a positive electrode layer is poor even if the positive electrode layer is produced by molding a mixture of lithium cobaltate and a sulfide solid electrolyte.

Then, an object of the present invention is to provide an all-solid-state battery utilizing a sulfide solid electrolyte, in which the strength of an electrode layer can be improved, and a method for producing the all-solid-state battery.

The present inventors have examined various types of constitutions for an electrode material containing an electrode active material and a sulfide solid electrolyte. As a result, the present inventors have found that the strength of an electrode layer can be increased by adding fibrous carbon to the electrode active material and the sulfide solid electrolyte, and arranging a plurality of fibrous carbon components of the fibrous carbon in such a manner that at least fibrous carbon components of the fibrous carbon which extend in the direction of lamination of the positive electrode layer, the solid electrolyte layer and the negative electrode layer exist in the electrode layer. On the basis of the finding, the all-solid-state battery and the method for producing the all-solid-state battery according to the present invention have the following features.

The all-solid-state battery according to the present invention includes a positive electrode layer, a negative electrode layer and a solid electrolyte layer interposed between the positive electrode layer and the negative electrode layer. At least one electrode layer selected from the positive electrode layer and the negative electrode layer contains an electrode active material, a sulfide solid electrolyte and fibrous carbon. The fibrous carbon includes at least fibrous carbon components that extend in the direction of lamination of the positive electrode layer, the solid electrolyte layer and the negative electrode layer.

In the all-solid-state battery according to the present invention, it is preferred that 25% or more of the fibrous carbon components of the fibrous carbon contained in the electrode layer form angles of 50 to 90° both inclusive with respect to a plane of lamination of the positive electrode layer, the solid electrolyte layer and the negative electrode layer.

In the all-solid-state battery according to the present invention, it is also preferred that the fibrous carbon is fixed to the sulfide solid electrolyte.

In the all-solid-state battery according to the present invention, it is also preferred that the electrode layer is the positive electrode layer.

When the electrode layer is the positive electrode layer, it is preferred that the positive electrode layer contains a positive electrode active material, and the positive electrode active material contains a lithium composite oxide having a polyanion structure represented by general formula: LiₐMₘXO_{b}F_{c} (wherein M represents at least one transition metal; X represents at least one element selected from the group consisting of B, Al, Si, P, Cl, Ti, V, Cr, Mo and W; and a, m, b and c represent numerical values respectively falling within the ranges represented by the formulae 0<a≦3, 0<m≦2, 2≦b≦4 and 0≦c≦1).

It is preferred that the lithium composite oxide is a phosphate compound.

It is preferred that the phosphate compound is lithium iron phosphate.

The method for producing an all-solid-state battery according to the present invention is a method for producing the above-mentioned all-solid-state battery, and includes the following steps:

(A) a step of mixing the electrode active material, the sulfide solid electrolyte and the fibrous carbon together to produce a mixture; and

(B) a step of compression-molding the mixture to produce a molded article.

The method for producing an all-solid-state battery according to the present invention preferably further includes the following step:

(C) a step of heating the molded article.

According to the present invention, the strength of a molded article of an electrode layer can be increased by adding fibrous carbon to the electrode active material and the sulfide solid electrolyte, and arranging a plurality of fibrous carbon components of the fibrous carbon in such a manner that at least fibrous carbon components of the fibrous carbon which extend in the direction of lamination of the positive electrode layer, the solid electrolyte layer and the negative electrode layer exist in the electrode layer, and therefore it becomes possible to produce a self-sustaining-type chargeable-dischargeable all-solid-state battery.

### BRIEF EXPLANATION OF THE DRAWINGS

FIG. 1 is a cross-sectional view which schematically illustrates a cross-sectional structure of a battery element of an all-solid-state battery as an embodiment according to the present invention.

FIG. 2 is a perspective view which schematically illustrates a battery element of an all-solid-state battery as an embodiment according to the present invention.

FIG. 3 is a perspective view which schematically illustrates a battery element of an all-solid-state battery as another embodiment according to the present invention.

FIG. 4 is a graph illustrating the results of the observation of a cross section of a positive electrode layer in an all-solid-state battery produced in the example of the present invention on a scanning electron microscope, i.e., the frequency distribution of angles which the long axis directions of fibrous carbon components of fibrous carbon contained in the positive electrode layer form with respect to the plane of lamination of the positive electrode layer.

### DETAILED DESCRIPTION OF THE INVENTION

Hereinbelow, embodiments of the present invention will be described with reference to the drawings.

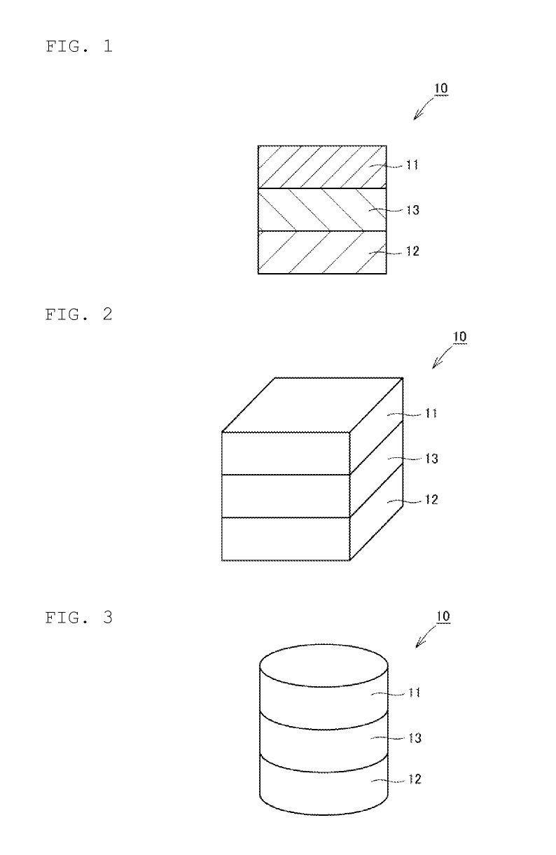

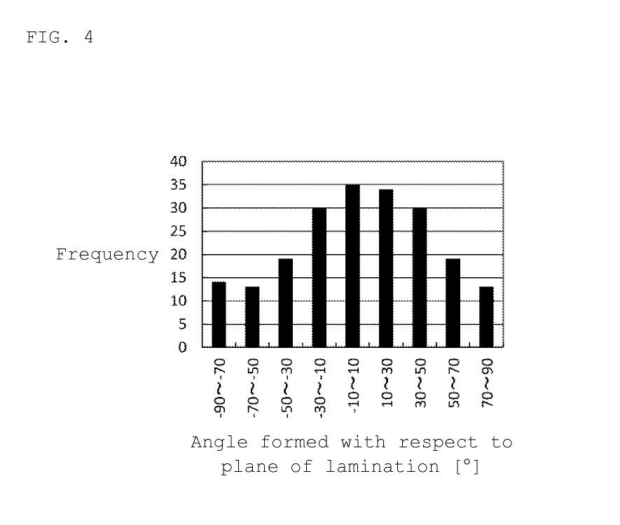

As illustrated in FIG. 1, an all-solid-state battery 10 according to the present invention includes a positive electrode layer 11, a negative electrode layer 12 and a solid electrolyte layer 13 interposed between the positive electrode layer 11 and the negative electrode layer 12. As illustrated in FIG. 2, as one embodiment of the present invention, the all-solid-state battery 10 is formed in a rectangular parallelepiped shape and is composed of a laminate of a plurality of flat-plate-shaped layers each having a rectangular flat surface. As illustrated in FIG. 3, as another embodiment of the present invention, the all-solid-state battery 10 is formed in a cylindrical shape and is composed of a laminate of a plurality of disc-shaped layers. Each of the positive electrode layer 11 and the negative electrode layer 12 contains a sulfide solid electrolyte and an electrode active material, and the solid electrolyte layer 13 contains a sulfide solid electrolyte.

At least one electrode layer selected from the positive electrode layer 11 and the negative electrode layer 12 contains fibrous carbon in addition to the electrode active material and the sulfide solid electrolyte. The fibrous carbon includes at least fibrous carbon components that extend in the direction of lamination of the positive electrode layer 11, the solid electrolyte layer 13 and the negative electrode layer 12.

As mentioned above, the strength of a molded article of an electrode layer can be increased by adding fibrous carbon to the electrode active material and the sulfide solid electrolyte, and arranging a plurality of fibrous carbon components of the fibrous carbon in such a manner that at least fibrous carbon components of the fibrous carbon which extend in the direction of lamination of the positive electrode layer, the solid electrolyte layer and the negative electrode layer exist in the electrode layer, and therefore it becomes possible to produce a self-sustaining-type chargeable-dischargeable all-solid-state battery.

It is preferred that 25% or more of the fibrous carbon components of the fibrous carbon contained in the electrode layer form angles of 50 to 90° both inclusive with respect to a plane of lamination of the positive electrode layer 11, the solid electrolyte layer 13 and the negative electrode layer 12. This configuration enables the improvement in the strength of a molded article of the electrode layer against an external force applied to the plane of lamination in a vertical direction.

It is preferred that the fibrous carbon is fixed to the sulfide solid electrolyte. This configuration enables the improvement in the moldability of the electrode layer, and also enables the improvement in battery properties.

Particularly when the fibrous carbon is fixed to the sulfide solid electrolyte by the compression molding of the electrode material, a stiff frame can be formed in the electrode layer. The electrode layer can become a stiff molded article by incorporating particles of the electrode active material into the frame. In this manner, it becomes possible to mold an electrode mixture formed of a mixture of an electrode active material and a sulfide solid electrolyte which can generally not be molded easily by press molding. Furthermore, when the resultant molded article is heated, the fibrous carbon is incorporated into the interfaces between particles of the solid electrolyte and then fused in the electrode layer and, as a result, the electrode layer becomes a stiffer molded article.

According to the present invention, since the strength of the electrode layer can be improved in the above-mentioned manner, the strength of the battery as a whole can also be improved greatly and the resistances at grain boundaries can be decreased. Particularly when an electrode layer containing fibrous carbon is used as the positive electrode layer 11, a self-sustaining-type all-solid-state battery 10 which can be operated without the need of applying an external pressure can be produced. Furthermore, since the molding of the electrode layer becomes possible merely by adding the sulfide solid electrolyte in a small amount, the energy density per weight or volume can also be improved.

Particularly when the positive electrode layer 11 contains the above-mentioned fibrous carbon, it is preferred that the positive electrode active material to be contained in the positive electrode layer 11 contains a lithium composite oxide having a polyanion structure represented by general formula: LiₐMₘXO_{b}F_{c} (wherein M represents at least one transition metal; X represents at least one element selected from the group consisting of B, Al, Si, P, Cl, Ti, V, Cr, Mo and W; and a, m, b and c represent numerical values respectively falling within the ranges represented by the formulae 0<a≦3, 0<m≦2, 2≦b≦4 and 0≦c≦1). When the above-mentioned lithium composite oxide is used as the positive electrode active material, the strength of a molded article of the positive electrode layer 11 can be improved by adding fibrous carbon to the sulfide solid electrolyte, and therefore it becomes possible to produce a self-sustaining-type chargeable-dischargeable all-solid-state battery. When the lithium composite oxide having a polyanion structure is used as the positive electrode active material, a discharge voltage can be increased compared with a case in which a sulfide is used as the positive electrode active material.

The lithium composite oxide is preferably a phosphate compound, and the phosphate compound is preferably lithium iron phosphate.

The above-mentioned constitutions, functions and effects of the present invention are based on the following considerations and findings by the present inventors.

As one means for improving the moldability, to increase the content ratio of the sulfide solid electrolyte in the electrode mixture can be conceived. However, the increase in the content ratio of the sulfide solid electrolyte leads to the decrease in the energy density as well as the disconnection of an electron-conducting path by the sulfide solid electrolyte existing in the electrode active material, resulting in the inoperativeness of the battery. For improving the moldability while maintaining a potential of the electrode active material, it is required to retain a network of an electron-conducting material using the sulfide solid electrolyte in an amount as small as possible while forming the network throughout the inside of the electrode layer.

Then, the present inventors have found that the above-mentioned condition can be achieved by adding fibrous carbon.

In the present invention, fibrous carbon acts as support rods in a structure of the electrode layer and also acts as electron-conducting paths. The solid electrolyte has only to fix the support rods, i.e., fibrous carbon, partially. In this manner, the amount of the solid electrolyte to be contained in the electrode layer is reduced compared with that in an electrode layer in a conventional all-solid-state battery in which a solid electrolyte itself plays a roll of supporting the structure. Furthermore, since fibrous carbon exists in the electrode layer randomly, fibrous carbon that acts as support rods for the structure also contributes to the improvement in the strength of the electrode layer as a whole, and therefore the mechanical strength of the electrode layer from every direction can be improved.

According to the present invention, for the above-mentioned reasons, the strength of a positive electrode layer can be improved using, for example, a lithium composite oxide having a polyanion structure, specifically lithium iron phosphate, as a positive electrode active material, and therefore it becomes possible to produce a self-sustaining-type all-solid-state battery.

The direction (orientation) in which fibrous carbon components of the fibrous carbon extend does not depend on the direction in which the electrode material is to be compressed, and it is preferred that the fibrous carbon components extend in every direction. Although fibrous carbon components of the fibrous carbon which extend in the direction parallel to the plane of lamination may exist in the electrode layer, it is required that fibrous carbon components of the fibrous carbon which extend in the direction of lamination, preferably in the direction that is almost vertical to the plane of lamination, exist in the electrode layer. This is because fibrous carbon components of the fibrous carbon which extend in a horizontal direction can act to increase the strength of the electrode layer when the electrode layer is displaced in a horizontal direction but cannot act to increase the strength of the electrode layer when the electrode layer is displaced in a vertical direction. In other words, if fibrous carbon components of the fibrous carbon which extend in an almost vertical direction do not exist, cleavage of the layer is likely to occur upon the application of an external pressure to the layer. Therefore, the strength of a molded article becomes poor after compression molding, and a self-sustaining-type all-solid-state battery cannot be produced. Furthermore, if fibrous carbon components of the fibrous carbon which extend in an almost vertical direction do not exist, the bonding between particles of the electrode active material in a vertical direction becomes weak due to the expansion/shrinkage of the electrode active material during the charging/discharging of the resultant battery, and electron-conducting paths and ion-conducting paths are disconnected. As a result, the battery properties are deteriorated.

For the above-mentioned reasons, it is required that at least fibrous carbon components of the fibrous carbon which extend in the direction of the lamination exist in the electrode layer.

Examples of the lithium composite oxide having a polyanion structure, which is a positive electrode active material constituting the positive electrode layer 11 in the all-solid-state battery 10 according to the present invention include LiFePO₄, LiCoPO₄, LiFe_{0.5}Co_{0.5}PO₄, LiMnPO₄, LiCrPO₄, LiFeVO₄, LiFeSiO₄, LiTiPO₄, LiFeBO₃, Li₃Fe₂PO₄, LiFe_{0.9}Al_{0.1}PO₄ and LiFePO_{3.9}F_{0.1}. For the purpose of improving the electron conductivity of the positive electrode active material, some of the elements in the above-mentioned positive electrode active materials may be substituted with other elements, or the surface of the lithium composite oxide may be coated with an electrically conductive substance such as carbon, or an electrically conductive substance may be encapsulated in particles of the positive electrode active material. These means do not inhibit the effect of the present invention and can be used suitably, and the employment of these means are also included within the scope of the present invention. The compositional ratio of elements that constitute the positive electrode active material is not limited to the above-mentioned ratios and may be deviated from the stoichiometric range.

The negative electrode layer 12 contains a negative electrode active material and a sulfide solid electrolyte. As the negative electrode active material, a carbon material such as graphite and hard carbon, an alloy-type material, sulfur, a metal sulfide or the like can be used.

The solid electrolyte layer 13 which is interposed between the positive electrode layer 11 and the negative electrode layer 12 contains a sulfide solid electrolyte.

The solid electrolyte to be contained in the positive electrode layer 11, the negative electrode layer 12 and the solid electrolyte layer 13 may be any one, as long as the solid electrolyte contains an ion-conducting compound, and may also be any one as long as the solid electrolyte contains at least lithium and sulfur as constituent elements. Examples of the compound include a mixture of Li₂S and P₂S₅ and a mixture of Li₂S and B₂S₃. It is preferred that the solid electrolyte contains phosphorus as a constituent element in addition to lithium and sulfur, and examples of the compound include a mixture of Li₂S and P₂S₅, Li₇P₃S₁₁ and Li₃PS₄. In these compounds, some of anions may be substituted with oxygen. Among the above-mentioned compounds, glass and a glass ceramic material each containing no bridging S atom and having a nominal composition of 80Li₂S-20P₂S₅ or the like and Thio-LISICON are preferred. The compositional ratio of elements that constitute the solid electrolyte is not limited to those mentioned above.

The all-solid-state battery 10 according to the present invention may be used in such a form that a battery element as illustrated in any one of FIG. 1 to FIG. 3 is placed in a ceramic container, or may be used in the form as illustrated in any one of FIG. 1 to FIG. 3 as a self-support-type battery.

The method for armoring the battery is also not limited particularly, and a metallic case, a mold resin, an aluminum laminate film and the like may be used.

In the method for producing the all-solid-state battery according to the present invention, the electrode active material, the sulfide solid electrolyte and the fibrous carbon are mixed together to produce a mixture, and the mixture is then compression-molded to produce a molded article.

In the method for producing the all-solid-state battery according to the present invention, it is preferred to further heat the molded article.

By heating the molded article, the bonding between the sulfide solid electrolyte and the fibrous carbon can be strengthened and the bonding between the sulfide solid electrolyte and the electrode active material can also be strengthened. Therefore, the mechanical strength of the electrolyte layer as a structure can be increased and the condition of the contact between the sulfide solid electrolyte and the electrode active material can also be improved, leading to the smooth migration of lithium ions. As a result, the resistivity of the battery can be decreased.

In the method for producing the all-solid-state battery 10 according to the present invention, each of the positive electrode layer 11, the negative electrode layer 12 and the solid electrolyte layer 13 can be produced by the compression molding of a raw material thereof. In this case, it is preferred that a raw material of the positive electrode layer 11 is compression-molded to produce a molded article, and the molded article is heated to produce the positive electrode layer 11. Subsequently, the positive electrode layer 11 and the negative electrode layer 12 are laminated on each other with the solid electrolyte layer 13 interposed therebetween, thereby producing a laminate.

Alternatively, each of the positive electrode layer 11, the negative electrode layer 12 and the solid electrolyte layer 13 can be produced by producing a solid-liquid mixture, such as a slurry, a paste or a colloid, which contains a raw material of the layer. In this case, firstly solid-liquid mixtures respectively containing raw materials of the positive electrode layer 11, the negative electrode layer 12 and the solid electrolyte layer 13 are produced (a solid-liquid mixture production step). Subsequently, molded articles, such as sheets, printed layers and films are produced respectively using the solid-liquid mixtures. The molded articles are laminated on one another, thereby producing a laminate (a laminate production step). The laminate may be sealed in, for example, a coin cell. The method for the sealing is not particularly limited. For example, the laminate may be sealed with a resin. Alternatively, the laminate may be sealed by applying an insulating material paste having an insulating property, such as Al₂O₃, to the surroundings of the laminate or dipping the laminate in the insulating material paste and then thermally treating the insulating material paste.

For the purpose of drawing an electric current from the positive electrode layer 11 and the negative electrode layer 12 with high efficiency, a current collector layer such as a carbon layer, a metal layer and an oxide layer may be formed on each of the positive electrode layer 11 and the negative electrode layer 12. An example of the method for forming the current collector layer is a sputtering method. Alternatively, a metal paste may be applied onto each of the positive electrode layer 11 and the negative electrode layer 12 or dipping each of the positive electrode layer 11 and the negative electrode layer 12 in a metal paste, followed by a thermal treatment of the metal paste. Alternatively, a carbon sheet may be laminated on each of the positive electrode layer 11 and the negative electrode layer 12.

In the laminate production step, it is preferred to form a single cell structure by laminating the positive electrode layer 11, the solid electrolyte layer 13 and the negative electrode layer 12 on one another. Furthermore, in the laminate production step, a plurality of laminates each having the above-mentioned single cell structure may be laminated on each other with a current collector interposed therebetween to form another laminate. In this case, the plurality of laminates each having the single cell structure may be electrically laminated in series or in parallel.

The method for producing each of the layers is not particularly limited. A doctor blade method, a die coater method, a comma coater method or the like may be employed for forming each of the layers in a sheet-like form, and a screen printing method or the like may be employed for forming each of the layers in the form of a printed layer or a film. The method for laminating the layers is not particularly limited. The lamination may be carried out employing a hot isostatic pressing method, a cold isostatic pressing method, an isostatic pressing method or the like.

The slurry can be produced by the wet mixing of an organic vehicle, which is prepared by dissolving an organic material in a solvent, with (the positive electrode active material and the solid electrolyte, the negative electrode active material and the solid electrolyte, or the solid electrolyte alone). In the wet mixing, a medium may be used. Specifically, a ball mill method, a viscomill method or the like may be employed. Alternatively, a wet mixing method using no medium may be employed, and a sand mill method, a high-pressure homogenizer method, a kneader dispersion method or the like may be employed. The organic material to be contained in the slurry is not particularly limited, and an acrylic resin or the like which cannot react with a sulfide can be used. The slurry may contain a plasticizer.

In the method for forming the positive electrode layer 11, the positive electrode active material, the sulfide solid electrolyte and the fibrous carbon are mixed together to produce a positive electrode mixture, and the positive electrode mixture is then compression-molded, thereby producing the positive electrode layer 11. In this case, the positive electrode layer 11 may be produced by producing a molded article from the positive electrode mixture and then heating the molded article. Alternatively, it may also be possible to laminate the positive electrode mixture on the solid electrolyte to produce a laminate and then heat the laminate, thereby producing a laminate of the positive electrode layer 11 and the solid electrolyte layer 13.

The heating conditions, such as the temperature and the atmosphere, to be employed for the heating of a molded article of the positive electrode mixture are not particularly limited, and it is preferred to carry out the heating of the molded article under conditions that do not adversely affect the properties of the resultant all-solid-state battery. It is preferred to heat the molded article at a temperature of 250° C. or lower in a vacuum atmosphere.

Next, an example of the present invention will be described concretely. However, the example mentioned below is intended to illustrate the invention and is not to be construed to limit the scope of the invention.

### EXAMPLES

Hereinbelow, an example and a comparative example in each of which an all-solid-state battery was produced will be described.

### Example

<Production of Solid Electrolyte>

A Li₂S powder and a P₂S₅ powder, which were sulfides, were mechanically milled together to produce a solid electrolyte.

Concretely, in an argon gas atmosphere, a Li₂S powder and a P₂S₅ powder were weighed in such a manner that the molar ratio of the Li₂S powder to the P₂S₅ powder became 80:20 and the powders were placed in an alumina container. Alumina balls each having a diameter of 10 mm were introduced into the container, and the container was hermetically sealed. The container was set on a mechanical milling apparatus (a Fritsch planetary ball mill, model P-7) and then subjected to a mechanical milling treatment at a rotating speed of 370 rpm for 20 hours. Subsequently, the container was opened in an argon gas atmosphere, toluene (2 ml) was introduced into the container, and then the container was hermetically sealed. The mechanical milling treatment was further carried out at a rotating speed of 200 rpm for 2 hours. A slurry-like material thus produced was filtrated in an argon gas atmosphere and then dried in vacuo to produce a powder. The powder was used as a glass powder for a positive electrode mixture.

The powder thus produced was heated at a temperature of 200 to 300° C. in a vacuum atmosphere to produce a glass ceramic powder. The glass ceramic powder was used in a solid electrolyte layer.

<Production of Positive Electrode Active Material>

FeSO₄.7H₂O was dissolved in pure water to produce an aqueous solution, and then H₃PO₄ (a 85% aqueous solution) that served as a P source and H₂O₂ (a 30% aqueous solution) that served as an oxidizing agent were added to the aqueous solution to produce a mixed aqueous solution. In this procedure, FeSO₄.7H₂O, H₃PO₄ and H₂O₂ were added in such a manner that the molar ratio among these compounds became 1:1:1.5.

Subsequently, pure water was added to acetic acid to produce an aqueous solution, and then ammonium acetate was dissolved in the aqueous solution to produce a buffer solution. The molar ratio of acetic acid to ammonium acetate was 1:1, and the concentration of each of acetic acid and ammonium acetate was 0.5 mol/L. When the pH value of the buffer solution was measured, it was 4.6.

The mixed aqueous solution was added dropwise to the buffer solution while stirring the buffer solution at ambient temperature, thereby producing a precipitated powder. The pH value of the buffer solution was decreased with the increase in the amount of the mixed aqueous solution to be added dropwise, and the dropwise addition of the mixed aqueous solution to the buffer solution was terminated when the pH value of the buffer solution became 2.0.

Subsequently, the resultant precipitated powder was filtrated, then washed with a large volume of water, then heated to a temperature of 120° C. and then dried, thereby producing a brown FePO₄.nH₂O powder.

Subsequently, the FePO₄.nH₂O powder was mixed with CH₃COOLi.2H₂O (lithium acetate dihydrate) at a molar ratio of 1:1, and pure water and a polycarboxylic acid-type polymeric dispersant were added to the resultant mixture. The mixture thus produced was agitated and pulverized using a ball mill, thereby producing a slurry. The slurry was dried using a spray drier, then granulated, and then thermally treated at a temperature of 700° C. for 5 hours in a H₂—N₂ mixed gas which was adjusted in a reductive atmosphere having an oxygen partial pressure of 10⁻²⁰ MPa, thereby producing a positive electrode active material (LiFePO₄).

<Production of Positive Electrode Mixture>

In an argon gas atmosphere, the glass powder which had been produced in the above-mentioned solid electrolyte production step, the positive electrode active material which had been produced in the above-mentioned procedure and gas-phase fibrous carbon manufactured by Showa Denko K.K. (trade name: VGCF, registered trade name: VGCF) that served as fibrous carbon were weighed in such a manner that the ratios of the amounts of these components became 60:34:6 by weight, and then mixed together using a rocking mill for 1 hour, thereby producing a positive electrode mixture.

<Production of Laminate of Positive Electrode Mixture and Solid Electrolyte>

The glass ceramic powder (25 mg) which had been produced in the above-mentioned solid electrolyte production step and the positive electrode mixture (5 mg) were introduced into a mold having a diameter of 7.5 mm in this order, and then press-molded at a pressure of 330 MPa, thereby producing a molded article.

The resultant molded article was placed on a carbon crucible and heated in a vacuum atmosphere at a temperature of 200° C. for 6 hours. In this manner, a laminate of the positive electrode mixture and the solid electrolyte was produced.

<Observation of Condition of Electrode Layer>

A cross section of the laminate produced as described above was observed on a scanning electron microscope (SEM) (a product by ERIONIX, model: ERA-8900FE). The cross section of the laminate was exposed in an argon gas atmosphere and then observed.

Images of ten areas in a view that was obtained by enlarging a part corresponding to the electrode layer (the positive electrode mixture) at a magnification of 10,000 were taken, and angles which the long axis directions of fibrous carbon components of the fibrous carbon formed with respect to the plane of lamination were measured. The result of the measurement, i.e., the frequency distribution of the angles which the long axis directions of the fibrous carbon components of the fibrous carbon formed with respect to the plane of lamination, is illustrated in FIG. 4.

The number of fibrous carbon components of the fibrous carbon which formed angles of 0 to 50° with respect to the plane of lamination and the number of fibrous carbon components of the fibrous carbon which formed angles of 50 to 90° with respect to the plane of lamination in FIG. 4 were counted, and it is found that the content ratios of the two kinds of the fibrous carbon components are 71% and 29%, respectively. From these results, it is found that there exist fibrous carbon components of the fibrous carbon which extend in the direction parallel to the plane of lamination as well as fibrous carbon components of the fibrous carbon which extend in the direction of lamination. In other words, it is found that 25% or more of fibrous carbon components of the fibrous carbon form angles of 50 to 90° both inclusive with respect to the plane of lamination.

In the observation of the electrode layer (positive electrode mixture) part, it was found that the grain boundaries disappeared in the solid electrolyte by the press molding and the subsequent heating, and the solid electrolyte existed in the form of masses each having a diameter of 1 μm or more.

<Production of All-Solid-State Battery>

In—Li which served as a negative electrode material was arranged on the solid electrolyte layer side of the laminate produced in the above-mentioned procedure, thereby producing a laminate that served as a battery element of an all-solid-state battery. The resultant laminate was sandwiched with stainless steel sheets and then sealed in a laminate container, thereby producing an all-solid-state battery. In the battery, a carbon sheet that served as a current collector was interposed between the positive electrode layer and the stainless steel sheet.

<Evaluation of Battery Properties>

With respect to the all-solid-state battery produced in the above-mentioned procedure, it was confirmed that the charging-discharging at a constant current of 10 μA (current density: 22.7 μA/cm²) at a voltage of 3.6 to 1.8 V can be achieved and a charging-discharging cycle at a temperature of 50° C. can be performed repeatedly. In the charge-discharge curve, a flat area was observed around a voltage of 2.8 V. Therefore, it was confirmed that the charging-discharging proceeded reversibly. The discharge capacity was 80 mAh/g per unit weight of the positive electrode active material and was 27.2 mAh/g per unit weight of the positive electrode mixture. As mentioned above, it was found that the battery produced in the example can work as a self-sustaining-type all-solid-state battery utilizing a sulfide solid electrolyte.

From the above-mentioned results of the example, it is found that a molded article can be produced from a positive electrode mixture which contains the solid electrolyte at a relatively small content ratio and also contains lithium iron phosphate, which is difficult to mold, as a positive electrode active material. It is considered that the success of the production of the molded article is due to the stiff bonding of the solid electrolyte to the network of three-dimensionally extending fibrous carbon components of the fibrous carbon.

It is considered that particularly 29% of fibrous carbon components of the fibrous carbon which extend in the direction that forms an almost vertical angle (50 to 90°) with respect to the plane of lamination can increase the strength against an external force applied to the plane of lamination in a vertical direction and therefore can act so as to prevent the collapse of the positive electrode layer during the production of the molded article, the assembly of the battery and the progress of charging and discharging of the battery.

Furthermore, since it was observed that the sulfide solid electrolyte bound stiffly and was formed in the form of large masses by press molding and subsequent heating, it is considered that the reason why the charging and discharging of the battery proceeded reversibly is that the solid electrolyte is bound stiffly to the fibrous carbon and is also bound stiffly to lithium iron phosphate that serves as a positive electrode active material by press molding and subsequent heating to improve the adhesion between the sulfide solid electrolyte and lithium iron phosphate. It is considered that the improvement in the adhesion between the sulfide solid electrolyte and lithium iron phosphate leads to the progress of the smooth migration of lithium ions between both the materials, resulting in the progress of the charging and discharging of the battery.

### Comparative Example

<Production of Solid Electrolyte> <Production of Positive Electrode Active Material>

A solid electrolyte and a positive electrode active material were produced in the same manner as in the example.

<Production of Positive Electrode Mixture>

In an argon gas atmosphere, the glass powder which had been produced in the above-mentioned solid electrolyte production step, the positive electrode active material which had been produced in the above-mentioned procedure and acetylene black that served as a granular conductive additive were weighed in such a manner that the ratios of the amounts of these components became 60:34:6 by weight, and then mixed together using a rocking mill for 1 hour, thereby producing a positive electrode mixture.

<Production of Laminate of Positive Electrode Mixture and Solid Electrolyte>

An attempt was made to produce a laminate of the positive electrode mixture and the solid electrolyte in the same manner as in the example. However, the laminate could be not molded. Therefore, it was impossible to produce a battery element of an all-solid-state battery.

<Observation of Condition of Positive Electrode Mixture>

The positive electrode mixture was observed on a scanning electron microscope in the same manner as in the example. The positive electrode mixture was observed at a magnification of 10,000, and it was confirmed that no fibrous carbon existed.

It should be understood that the embodiments and examples disclosed herein are illustrative only and not restrictive in all respects. The scope of the present invention is defined by the appended claims rather than the foregoing embodiments and examples, and all changes and modifications that fall within the equivalent meaning and scope of the claims are intended to be included within the scope of the present invention.

According to the present invention, an all-solid-state battery utilizing a sulfide solid electrolyte, which is of a self-sustaining-type and is chargeable-dischargeable, can be produced.

### DESCRIPTION OF REFERENCE SYMBOLS

10 all-solid-state battery

11 positive electrode layer

12 negative electrode layer

13 solid electrolyte layer

1. An all-solid-state battery comprising:
a positive electrode layer;
a negative electrode layer; and
a solid electrolyte layer interposed between the positive electrode layer and the negative electrode layer,
wherein at least one electrode layer selected from the positive electrode layer and the negative electrode layer comprises an electrode active material, a sulfide solid electrolyte and fibrous carbon, and
wherein the fibrous carbon comprises at least fibrous carbon components that extend in a direction of lamination of the positive electrode layer, the solid electrolyte layer and the negative electrode layer.

2. The all-solid-state battery according to claim 1, wherein 25% or more of the fibrous carbon components of the fibrous carbon contained in the electrode layer form angles of 50 to 90°, both inclusive, with respect to a plane of lamination of the positive electrode layer, the solid electrolyte layer and the negative electrode layer.

3. The all-solid-state battery according to claim 1, wherein the fibrous carbon is fixed to the sulfide solid electrolyte.

4. The all-solid-state battery according to claim 3, wherein the fibrous carbon is located in interfaces between particles of the sulfide solid electrolyte.

5. The all-solid-state battery according to claim 1, wherein the fibrous carbon is located in interfaces between particles of the sulfide solid electrolyte.

6. The all-solid-state battery according to claim 1, wherein the electrode layer is the positive electrode layer.

7. The all-solid-state battery according to claim 6,
wherein the positive electrode layer contains a positive electrode active material,
the positive electrode active material comprises a lithium composite oxide having a polyanion structure represented by LiₐMₘXO_{b}F_{c},
M is at least one transition metal;
X is at least one element selected from the group consisting of B, Al, Si, P, Cl, Ti, V, Cr, Mo and W;
0<a≦3,
0<m≦2,
2≦b≦4, and
0≦c≦1.

8. The all-solid-state battery according to claim 7, wherein the lithium composite oxide is a phosphate compound.

9. The all-solid-state battery according to claim 8, wherein the phosphate compound is lithium iron phosphate.

10. A method for producing the all-solid-state battery as recited in claim 1, the method comprising:
mixing the electrode active material, the sulfide solid electrolyte and the fibrous carbon together to produce a mixture; and
compression-molding the mixture to produce a molded article.

11. The method according to claim 10, further comprising heating the molded article.
